(19) United States
(12) Patent Application Publication
(10) Pub. No.: US 2008/0066353 A1
(43) Pub. Date: Mar. 20, 2008

(54) Advertising and promotional article

(76) Inventor: Densley Mills, South Australia 5000 (AU)

Correspondence Address: PATE PIERCE & BAIRD, 175 SOUTH MAIN STREET, SUITE 1250, SALT LAKE CITY, UT, 84111, US

(21) Appl. No.: 11/903,520

(22) Filed: Sep. 20, 2007

(30) Foreign Application Priority Data
Sep. 20, 2006 (AU) 2006905184

(51) Int. Cl. G09F 1/06

(52) U.S. Cl. 40/124.19

(57) ABSTRACT

An advertising display apparatus for a loop shaped passenger assistance handle, the display including a body that is shaped and adapted to envelope at least an upper portion of the loop shaped passenger assistance handle.

### BACKGROUND

1. Field of the Invention

The present disclosure relates generally to an advertising display apparatus and, more specifically, to an advertising display apparatus for passenger assistance handles of the kind commonly found on buses, commuter trains, trams and other public transit vehicles.

2. The Background Art

In this specification unless the contrary is expressly stated, where a document, act or item of knowledge is referred to or discussed, this reference or discussion is not to be construed as an admission that the document, act or item of knowledge or any combination thereof was at the priority date, publicly available, known to the public, part of common general knowledge; or known to be relevant to an attempt to solve any problem with which this specification is concerned.

It is known to position poster-style advertisements in the interior of public transit vehicles of the type mentioned above. These posters are typically placed above the windows, so that they extend up onto the ceiling of the bus or carriage as the case may be. As such, it is relatively easy to ignore these posters, as one must turn their head up and/or to the side to look at them.

It is an object of the present invention therefore to provide a means of advertising on public transit vehicles that places the advertising as close to the eye level of a standing passenger as practically possible, or at the least, provide a useful alternative to known advertising techniques employed on public transit vehicles.

Practically all of the forms of public transport mentioned above are equipped with passenger assistance handles, which are provided so that passengers may have something to hold onto when standing or moving about the bus or carriage as the case may be.

These passenger assistance handles typically take the form of either a length of flexible strap or a rigid plastic moulding that is suspended from an overhead railing so as to provide a loop that is sized so that it may be grasped by a hand.

The flexible strap variants include a main loop that is sized so that it may be grasped by a hand, a second loop that passes around the overhead railing, and a necked portion where the two loops meet and the ends of the strap are fixed to one another.

Similarly, the rigid plastic moulded handles include a main loop that is sized so that it may be grasped by a hand, and means for connecting this main loop to an overhead railing.

It is a further object of the invention therefore to provide a means for effecting the display of advertising or promotional material that may be affixed or attached to these passenger assistance handles, without adversely affecting the utility of the handle.

It is yet a further object of the invention to provide a means of advertising that may be quickly and easily retrofitted to existing passenger assistance handles.

Other objects and advantages of the present invention will become apparent from the following description, taken in connection with the accompanying drawings, wherein, by way of illustration and example, an embodiment of the present invention is disclosed.

For the purpose of this specification, the word “comprising” means “including but not limited to,” and the word “comprises” has a corresponding meaning.

### BRIEF SUMMARY OF THE INVENTION

One aspect of the present disclosure includes an advertising display apparatus for a loop shaped passenger assistance handle, the display comprising a body that is shaped and adapted to envelope at least an upper portion of the loop shaped passenger assistance handle.

Preferably, the body is adapted to carry indicia thereon.

Preferably, the body is a sheet of material forming a loop around the loop shaped passenger assistance handle.

Preferably, the sheet of material is flexible and pliable.

Preferably, the advertising display apparatus surrounds the upper half to two-thirds of the loop shaped passenger assistance handle, whilst leaving the lower portion of the loop shaped passenger assistance handle exposed so that a passenger may grasp it if required.

Preferably, the advertising display apparatus is formed from a blank that is wrapped around the loop shaped passenger assistance handle, and fixed in place by connecting a first end of the blank to a distal end thereof.

Preferably, the blank has a pair of opposing sides, at least one of which carries the indicia.

Preferably, the indicia carrying side of the blank is faced outwardly when the blank is applied to the loop shaped passenger assistance handle.

Preferably, the blank includes means adapted to allow the ends thereof to be connected.

Preferably, the ends of the blank are fixed in place by applying an adhesive thereto.

Preferably, the ends of the blank are adapted to interlock.

Another aspect of the present disclosure includes an advertising display apparatus for a passenger assistance handle including a body that is shaped and adapted to pass around and thereby surround at least an upper portion of a loop shaped portion of the passenger assistance handle.

Another aspect of the present disclosure includes an advertising display apparatus for a loop shaped passenger assistance handle, the display including a body having a pair of substantially planar, indicia bearing faces that extend across at least an upper portion of the two open faces of the loop shaped passenger assistance handle.

Another aspect of the present disclosure includes a method of applying the advertising display apparatus as described above, to a loop shaped passenger assistance handle, including the steps of wrapping the blank around the upper portion of the loop shaped handle, and fixing the display in place by connecting a first end of the blank to a distal end thereof.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings, which are incorporated in and constitute a part of this specification, illustrate certain embodiments of the invention, and together with the description, serve to explain the principles of the invention.

Those skilled in the art will appreciate that the conception upon which this disclosure is based may readily be utilized as a basis for designing other structures, methods, and systems for carrying out the several purposes of the present invention. It is important, therefore, to recognize that the claims should be regarded as including such equivalent constructions insofar as they do not depart from the spirit and scope of the present invention.

### BRIEF DESCRIPTION OF THE DRAWINGS

For a better understanding of this disclosure it will now be described with respect to an exemplary embodiment which shall be described herein with the assistance of drawings wherein:

FIGS. 1 and 2 are perspective views of a passenger assistance handle, with an advertising display apparatus fitted thereto;

FIG. 3 is a plan view of the blank used to form the advertising display apparatus as shown in FIGS. 1 and 2;

FIG. 4 is a perspective view of an advertising display apparatus according to a further embodiment of the invention; and

FIG. 5 is a plan view of the blank used to form the advertising display apparatus as shown in FIG. 4.

### DETAILED DESCRIPTION OF THE INVENTION

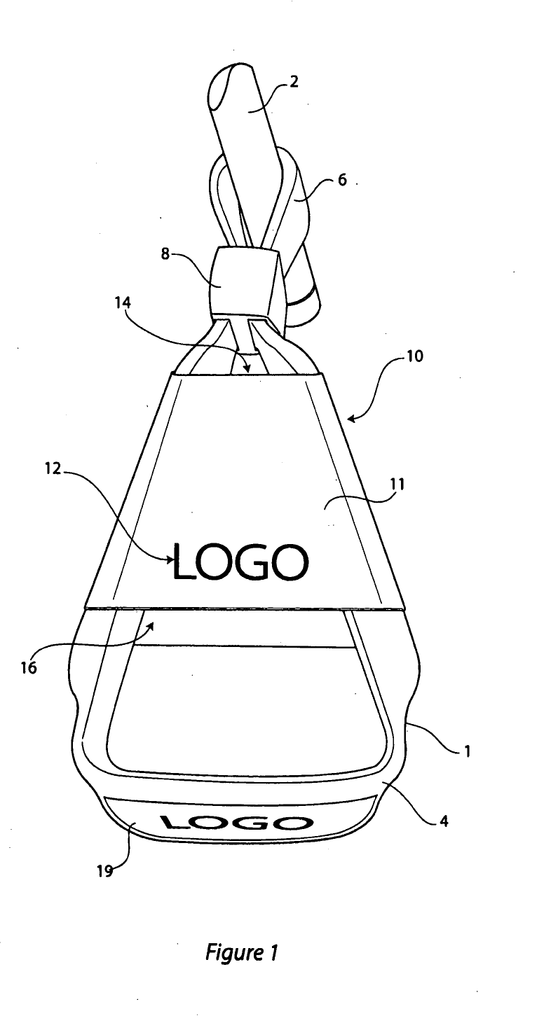

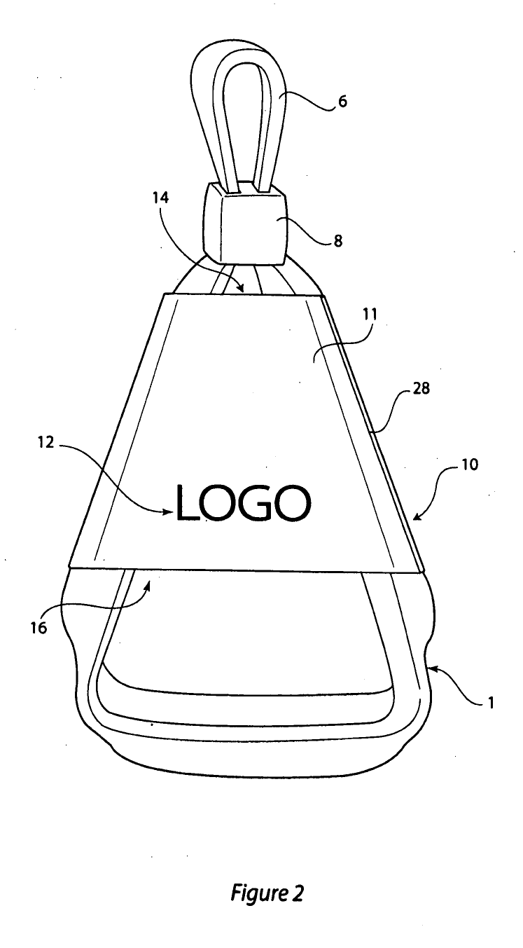

Referring not to FIG. 1, where an exemplary embodiment of an advertising display apparatus for a loop shaped passenger assistance handle is illustrated. More specifically, there is illustrated a generally loop shaped passenger assistance handle 1 made from a rigid moulded plastic that is suspended from an overhead railing 2 at or about the head or eye level of a standing passenger. The handle 1 includes a main loop 4 that is sized so that it may be grasped by a hand, a second loop 6 that passes around the overhead railing 2, and a necked portion 8 where the two loops meet.

An advertising display apparatus 10 is wrapped around the upper portion of the main loop 4 of the handle 1 so as to surround the upper half to two-thirds of the main loop 4, whilst leaving the lower portion of the handle 1 well exposed so that a passenger may grasp it, if required. Applying the display 10 to the upper portion of the main loop 4 also ensures that the display cannot fall off the handle 1, as the handle widens beneath it.

The portion of the main loop 4 covered by the advertising display apparatus 10 (the upper portion) is very rarely used by passengers, as these handles 1 are almost always grasped by the lowermost portion of the main loop. The area subtended by the upper part of the main loop 4 of the handle 1 (i.e., the main loops face) is otherwise wasted space then, which is ideal for advertising due to its presence at or near the eye level of a standing passenger.

The advertising display apparatus 10 may provide a pair of substantially planar main faces 11 that extend across the two faces of the main loop 4, and a pair of side faces that rest atop the sides of the main loop. These two substantially planar main faces 11 are ideal for the placement of advertising or promotional indicia 12 thereon.

What's more, additional advertising indicia 19 corresponding with that on the advertising display apparatus 10 may be applied to the lowermost part of the handles main loop 4 for extra effect. This additional advertising indicia 19 can be in the form of a sticker, or it can take the form of a sleeve that wraps around this portion of the main loop.

The advertising display apparatus 10 may be made from a sheet of tough but flexible material such as a suitable plastic, or indeed even a paper or cardboard.

The advertising display apparatus 10 has openings in its top and bottom through which the strap passes 1, the top opening 14 being much smaller than the bottom opening 16.

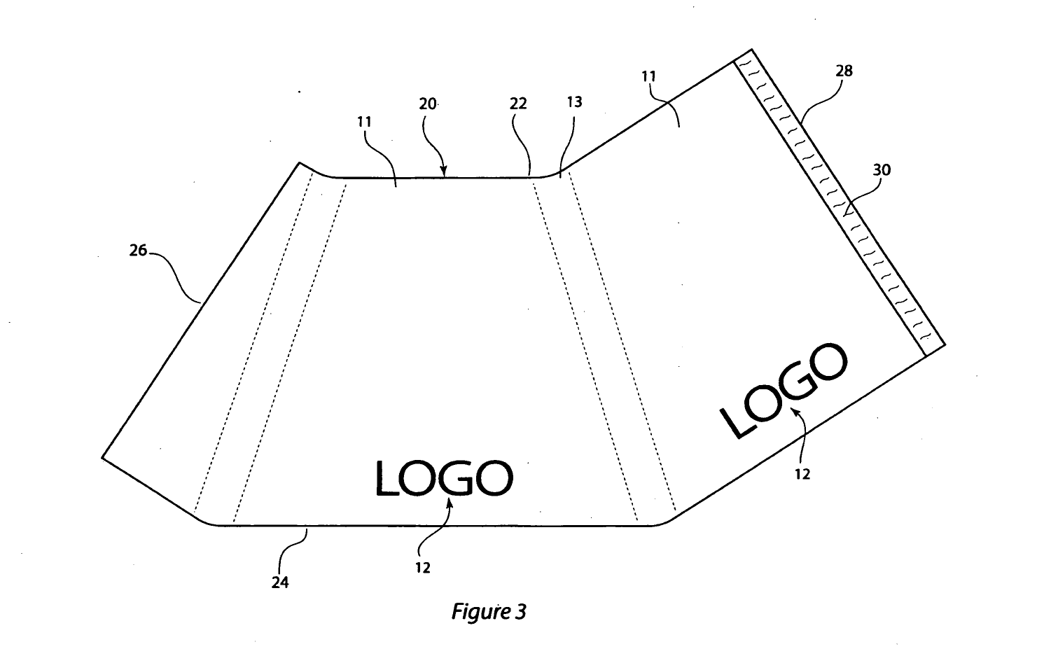

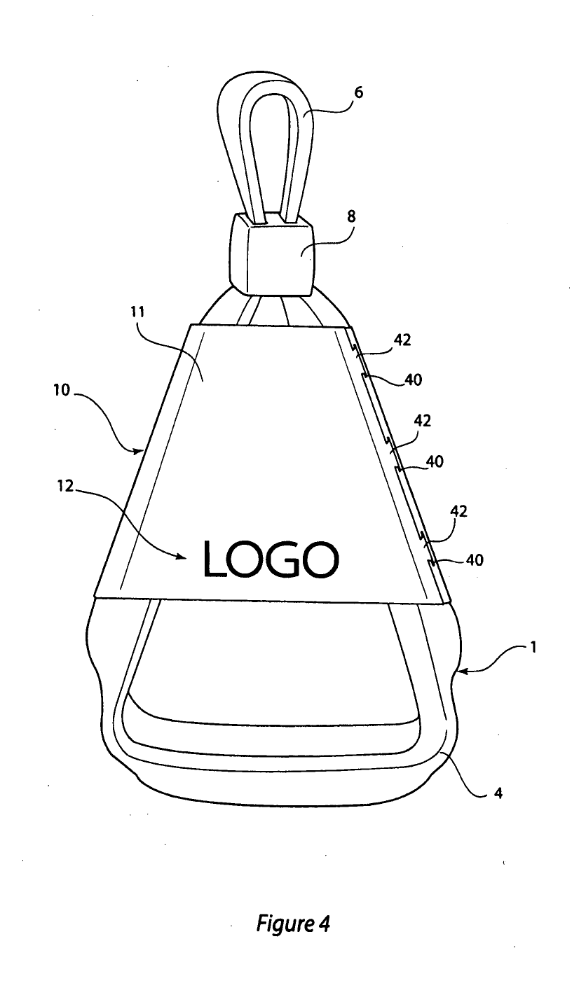

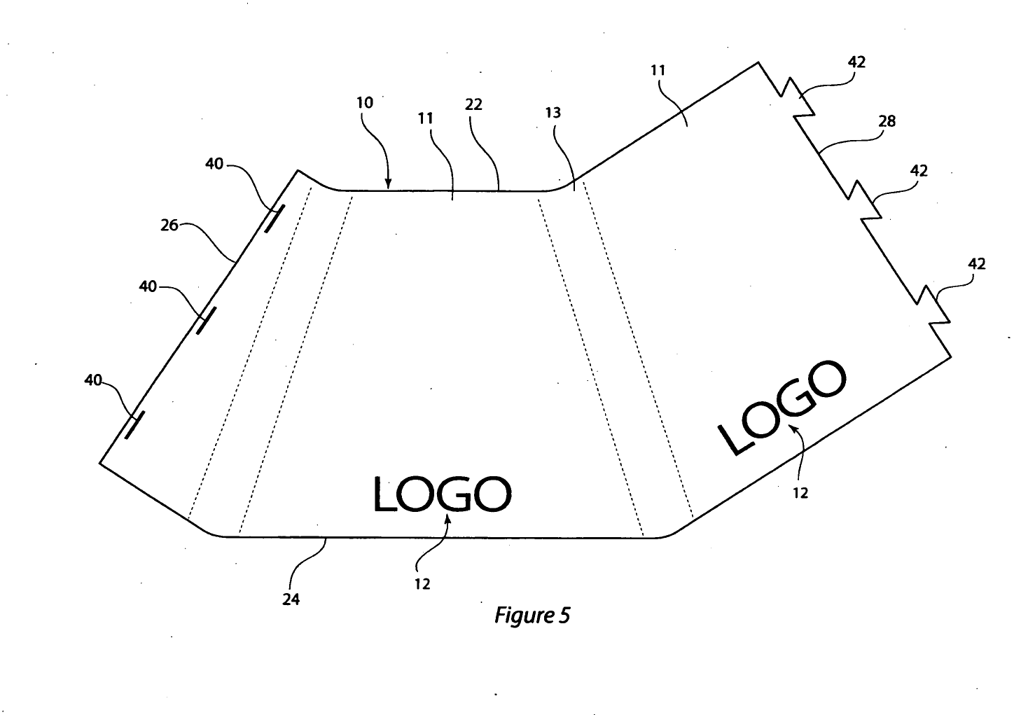

Referring now to FIG. 3, where there is illustrated a blank 20 from which an advertising display apparatus may be made. The blank 20 comprises a first side face 13 having a main face 11 to either side of this, each of these main side faces 11 having a portion of the further side face extending from a distal edge thereof.

The blank has top 22 and bottom 24 edges that are substantially parallel to one another, and a pair of side edges 26 and 28. The blank has an inner side and an outer side with the advertising indicia 12 thereon. Positioned on the inner side of the blank near one of the side edges may be a strip of adhesive material 30.

In use, when the advertising display apparatus 10 is to be applied, the blank 20 may be wrapped around the handle 1 so that the top edge 22 of the blank is close to the neck 8 of the strap. The edge 28 of the blank with the adhesive strip 30 on it is then passed over the top of the other edge 26, and once a close fit is achieved over the top of the handle 1, the uppermost edge 28 is then pressed down onto the lower one 26 effecting a joining of the two along a side edge thereof. This leaves the main side faces 11 of the display 10 clear to accept advertising thereon.

In a further form, the blank 10 may incorporate a series of slits or slots 40 near a first side edge 26, and the series of corresponding tabs 42 near the other side edge 28. In use then, the blank 20 is wrapped around the handle 1 so that the top edge 22 of the blank 20 is close to the neck 8 of the handle, and the tabs 42 are then engaged in the slits or slots 40 so as to effect a joining in a side face of the display. These slits or slots 40 should be positioned so that a close fit is achieved over the handle 1 when the tabs 42 are inserted.

In yet a further form, the blank 10 may be secured in position around a handle 1 by applying an adhesive from a tube or gun near a first edge thereof, and then pressing the two edges together to effect a joining of these.

It is envisaged that at any given time, all of the passenger assistance handles 1 on a carriage or bus may be covered by advertising display apparatus 10 bearing the same indicia. This would effectively promote the goods or services of the parties whose indicia is born by the advertising display apparatus.

It is considered that the advertising display apparatus according to the present invention will be of particular use to both companies wishing to advertise their products or services on public transit vehicles, and the vehicles operators, as they can derive income from allowing the display devices to be fitted.

Although the invention has been herein shown and described in what is conceived to be the most practical and preferred embodiment, it is recognized that departures can be made within the scope of the invention, which is not to be limited to the details described herein but is to be accorded the full scope of the appended claims so as to embrace any and all equivalent devices and apparatus.

What is claimed and desired to be secured by United States Letters Patent is:

1. An advertising display apparatus for a loop shaped passenger assistance handle, the display comprising a body that is shaped and adapted to envelope at least an upper portion of the loop shaped passenger assistance handle.

2. The advertising display apparatus of claim 1, wherein the body is adapted to carry indicia thereon.

3. The advertising display apparatus as in claim 1, wherein the body is a sheet of material forming a loop around the loop shaped passenger assistance handle.

4. The advertising display apparatus of claim 3, wherein the sheet of material is flexible and pliable.

5. The advertising display apparatus as in claim 1, wherein the advertising display apparatus surrounds the upper half to two-thirds of the loop shaped passenger assistance handle, whilst leaving the lower portion of the loop shaped passenger assistance handle exposed so that a passenger may grasp it if required.

6. The advertising display apparatus as in claim 4, wherein the advertising display apparatus is formed from a blank that is wrapped around the loop shaped passenger assistance handle, and fixed in place by connecting a first end of the blank to a distal end thereof.

7. The advertising display apparatus of claim 6, wherein the blank has a pair of opposing sides, at least one of which carries the indicia.

8. The advertising display apparatus of claim 7, wherein the indicia carrying side of the blank is faced outwardly when the blank is applied to the loop shaped passenger assistance handle.

9. The advertising display apparatus as in claim 6, wherein the blank includes means adapted to allow the ends thereof to be connected.

10. The advertising display apparatus of claim 9, wherein the ends of the blank are fixed in place by applying an adhesive thereto.

11. The advertising display apparatus of claim 9, wherein the ends of the blank are adapted to interlock.

12. An advertising display apparatus for a passenger assistance handle including a body that is shaped and adapted to pass around and thereby surround at least an upper portion of a loop shaped portion of the passenger assistance handle.

13. An advertising display apparatus for a loop shaped passenger assistance handle, the display including a body having a pair of substantially planar, indicia bearing faces that extend across at least an upper portion of the two open faces of the loop shaped passenger assistance handle.

14. A method of applying the advertising display apparatus as described in claim 1 to a loop shaped passenger assistance handle, including the steps of wrapping the ends of an advertising display apparatus forming blank around an upper portion of the loop shaped handle, and fixing the display in place by connecting a first end of the blank to a distal end thereof.
